(19) United States
(12) Patent Application Publication
(10) Pub. No.: US 2003/0233888 A1
(43) Pub. Date: Dec. 25, 2003

(54) Device to determine a torque value within a transmission

(76) Inventor: Armin Gierling, Langenargen (DE)

Correspondence Address: Steven M. Hoffberg, Milde & Hoffberg LLP, Suite 460, 10 Bank Street, White Plains, NY, 10606, US

(21) Appl. No.: 10/424,366

(22) Filed: Apr. 25, 2003

(30) Foreign Application Priority Data
Jun. 25, 2002 (DE) 102 28 216.1

(51) Int. Cl. G01L 3/02

(52) U.S. Cl. 73/862.31

(57) ABSTRACT

A system and method for determining a torque value within a transmission, whereby an actual torque is determined from an axial force of a torque-transmitting helical gear wheel in the transmission, particularly from a measured bearing force of this gear wheel.

### FIELD OF THE INVENTION

The present invention relates to a device to determine a torque value within a transmission, whereby an actual torque is determined from an axial force of a torque-transmitting helical gear wheel in the transmission, particularly from a measured bearing force of this gear wheel.

### BACKGROUND OF THE INVENTION

Several systems are known to determine torques passed to a component, e.g., a transmission. Torque measurement hubs are often used in which the torsion of a hub section under torsion load is measured electrically, using expansion measurement strips affixed to the hub section, and from this, the value of the imparted torsion may be determined by means of known materials data of this hub section. The power supply for these expansion measurement strips and the measurement signals is usually provided via slip rings or via induction from the hub section on which the expansion measurement strips are positioned, to a non-rotating exterior component of the torque measurement hub, and from there into an electronic evaluation unit that presents torque as its Output signal. Disadvantageously, installation space and costs of such torque measurement hubs are high, particularly for high demands for accuracy of the measured value.

Additionally, systems to determine torque are known, in which two revolution sensors are positioned on a measurement shaft of defined torsion stiffness, at a defined axial separation from each other. During a torsion load on the measurement shaft, the applied torque is calculated from the phase displacement between the revolution signals of the two revolution sensors. The axial installation space requirement for such a torque determination device is high, as is the cost of the two sensors and the measurement shaft.

DE 196 33 380 A1 describes a torque determination device, that also operates based on the phase-displacement measurement principle between two rotating elements. For this, the first rotation element is connected with an input shaft, by means of which the torque to be determined is introduced. The second rotation element is positioned coaxially to the first rotation element, and is connected with an Output shaft of the torque determination device. The connection between the two shafts is via an elastic element that deforms based on the torque applied to it. The two rotation elements are rotated with respect to each other by this deformation. As a result of their spatial alignment, the two rotation elements may be sampled by means of a single sensor that produces an output signal that represents the surface structure of the two rotation elements. By evaluation of the temporal displacement in the sensor signal, a subsequent evaluation allows calculation of the torque acting on the elastic element between the two shafts of the torque determination device. The elastic element may consist of the same material as the shafts, or it may be implemented as a spring between the two rotation elements.

Finally. DE 197 37 626 C2 describes a system to determine the drive torque of a torque-converter automatic transmission, in which the drive torque is calculated from the moment about the points of support of the torque converter. As known, a conventional torque converter includes a hydraulic circuit with a driven pump wheel, a turbine wheel as drive, and a guide wheel to increase torque, whereby the guide wheel rests on a freewheel on the automatic transmission housing. DE 197 37 626 C2 recommends positioning a measurement shaft between the freewheel of the guide wheel and the automatic transmission housing. This measurement shaft transfers the moment about the points of support of the torque converter of the guide wheel to a rotationally-elastic hydraulic measurement device, from whose sweep angle a hydraulic signal equivalent to the torque is generated. This system assumes the presence of a torque converter, and only produces torque values as long as the drive moment is transferred via the hydraulic circuit of the torque converter, and the torque converter has positive power applied to it, i.e., the pump speed exceeds that of the turbine.

### SUMMARY OF THE INVENTION

It is one object of the present invention to present a universally-applicable, low-cost torque determining system, with a low construction cost and minimal installation space requirements. Other objects will be apparent from the description herein-below.

According to the present invention, it is proposed to determine torque actually applied to the gear wheel from an axial force of a torque-transferring helical gear of a transmission, particularly from a measured bearing force of this gear. The axial force of the torque-transferring helical gear produces a signal equivalent to the torque. By knowing the mechanical connection of other components to the gear wheel and the corresponding geometric data, torque thus determined may be converted in a simple, conventional manner to a torque actually acting on another element of the transmission such as a shifting element, for example.

Known methods for the calculation of bearing forces in helical gears may be used according to the present invention. In principle, the actual axial force F_ax of a helical gear is a function of the obliqueness beta of the angle, and a function of the actual transferred peripheral force F_t that is applied to the gear wheel at the effective radius r where the gear teeth mesh with the gear. For this, the peripheral force F_t is a function of the applied torque Md. In the ideal case, particularly with non-defective stiff toothing, consistent and suitable lubrication, and constant stiffness values, the following equation (1) applies:

Md=F_{—}t*r=(F_ax/tan(beta))*r (1)

Based on the present invention, the axial force of at least one bearing of the helical gear wheel is measured. In an advantageous embodiment, a measurement washer is provided between the gear wheel and its axial bearing support surface, to measure static and dynamic forces. Such measurement washers are known. They operate based on piezo-resistance, and are thus well suited for the measurement of dynamic and highly-dynamic forces. The actual axial force thus measured is equivalent to the torque applied to the toothing.

In an exemplary device to determine torque, the measured axial force F_ax of the helical gear wheel is converted to the torque value Md that was applied to the gear wheel, and is available as an output signal to the devices to determine torque and/or to control devices for further processing. It may also be arranged so that the device to determine torque is integrated directly into a subsequent control device.

One may also advantageously resort to a known and tested component that is required as an additional component to the gear wheel and bearing components already involved. Known measurement washers, to measure force, thus require only a small installation space, particularly regarding length, and are also inexpensive in comparison to the known torque sensors.

In another embodiment of the invention, the measurement device to measure axial force in the helical gear may be integrated directly into the bearing on which the gear wheel rests axially. Integration of the measurement device to measure axial force in the helical gear itself may also be provided.

According to another embodiment of the invention, two measurement washers are arranged to measure the static and dynamic axial forces in the helical gear wheel, whereby the first measurement washer measures axial forces of the helical gear in the positive torque direction, and the second measurement washer measures axial forces of the helical gear in the negative torque direction. The above-mentioned assigning of torque direction is understood to mean that, upon application of positive torque to the gear wheel, it is driven by an input shaft of the transmission. Correspondingly, when negative-direction torque is present at the gear wheel, the torque flow is from an output shaft of the transmission via the gear wheel to the input shaft of the transmission. In a simplified form of this embodiment of the invention, the helical gear wheel is positioned axially between the two measurement washers, and rests axially via the measurement washers on two bearings. In a particularly advantageous manner, this embodiment of the invention allows determination of the actual torque in both directions, whereby the necessary additional construction expense is comparatively small. Alternately, a preload is provided on the shaft, allowing bidirectional measurement using a single measurement washer.

In practice, there are no ideal prerequisites on the helical gear wheel at which the axial force measurement occurs, as was the case in the above-mentioned simple formula. Deviating prerequisites are in particular caused by additional internal forces, resulting from meshing defects and deformations, by actual lubrication conditions with the actual, changing circumferential speed viscosity, and surface roughness, as well as by special geometric configurations of the toothing such as, for example, a fillet. To compensate for such defects, a correction factor K may be provided during calculated conversion of the measured axial force into the torque value applied to the helical gear, so that, for example, the equation (2)

Md=K*(F_ax/tan(beta))*r (2)

applies.

The correction factor K may be determined empirically by advance testing, and may then be fixed as a constant or as a function. As previously explained, the dependence on the circumferential speed of the toothing and on the viscosity or lubricant temperature may be taken into account in this function. In another embodiment, the correction factor K may also be adaptable. For example, a lookup table, mathematical function (or operating regime-specific mathematical function), transform, or mapping relationship. See, e.g., U.S. Pat. Nos. 5,940,065 and 6,506,983, expressly incorporated herein by reference, relating to the development and use of mapping relationships. K may be dependent on transmission temperature or fluid viscosity. Preferred application sites of the device to determine torque based on the invention, are multi-ratio automatic transmissions in which calculable torque information is important, especially to control shifting elements and, if present, for on-demand control of the contact pressure of the drive-ratio adjustment actuator. If positioned at the drive side, the device to determine torque can be used to easily determine the input torque value. If positioned at the output side, the device to determine torque may easily determine output torque, e.g., to protect a CVT actuator from output-side torque shocks or to control pressure based on output torque in a transmission hill-holder consisting of one of two blocked shifting elements.

### BRIEF DESCRIPTION OF THE DRAWING

FIG. 1 shows a simplified embodiment of a torque-sensing arrangement according to the present invention.

### DETAILED DESCRIPTION OF THE PREFERRED EMBODIMENTS

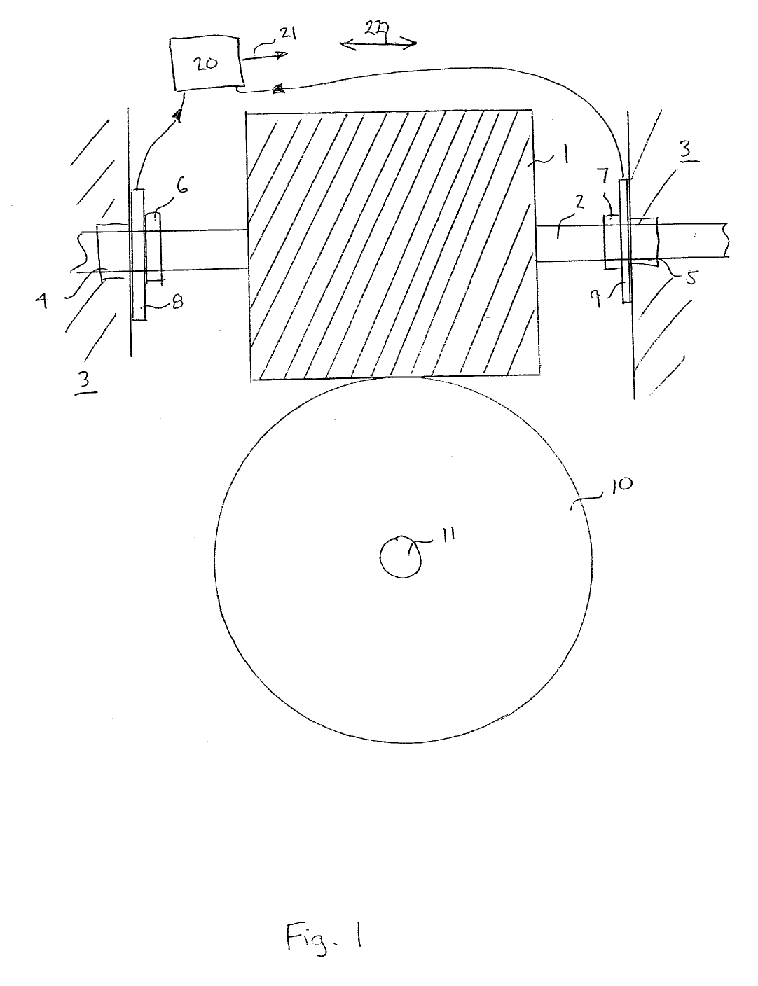

FIG. 1 shows a helical gear 1, on shaft 2, mounted in a housing 3 by bearings 4, 5. The shaft has an enlarged radius sections 6, 7, which exert a force against a force-sensing washer 8, 9. The force-sensing washer 8, 9, may be separate, integrated in the bearings 4, 5, or integrated into the helical gear 1. The force-sensing washer 8, 9, is, for example, a piezoelectric transducer.

A spur gear 10, mounted on shaft 11, mated with helical gear 1.

A control 20 receives electrical signals from the force sensing washers 8, 9, and produces an output 21 representative thereof, of a force 22 on the axial shaft 2, or is converted into a torque value applied to the helical gear wheel.

While the above detailed description has shown, described and pointed out the fundamental novel features of the invention as applied to various embodiments, it will be understood that various omissions and substitutions and changes in the form and details of the system and method illustrated may be made by those skilled in the art, without departing from the spirit of the invention. Consequently, the full scope of the invention should be ascertained by the appended claims.

What is claimed is:

1. A device for determining torque in a transmission, whereby a torque actually applied, is determined based on an actual measured axial force on a bearing of a torque-transferring helical gear wheel of the transmission.

2. A device as in claim 1, wherein the measured value of the helical gear wheel is determined as a static or dynamic measurement value of at least one bearing of the helical gear wheel.

3. A device as in claim 1, wherein at least one measurement washer is provided as a measurement device, to determine the axial force of the helical gear wheel, positioned between the gear wheel and its respective axial contact surface on the bearing.

4. A device as in claim 1, wherein the axial force on the bearing is measured by a measurement device integrated into a bearing on which the gear wheel rests axially.

5. A device as in claim 1, wherein a measurement device to determine the axial force of the helical gear wheel is integrated into the helical gear.

6. A device as in claim 1, wherein two measurement washers are provided as a measurement device to determine the axial force of the helical gear wheel, whereby the first measurement washer measures axial forces of the helical gear wheel in a first torque direction, and the second measurement washer measures axial forces of the helical gear in a second torque direction.

7. A device as in claim 6, wherein the helical gear wheel is positioned between the two measurement washers and rests axially via the measurement washers on two bearings.

8. A device as in claims 1, wherein measurement of the axial force is performed using the piezo-resistive effect.

9. A device as in claims 1, wherein the measured axial force of the helical gear wheel is converted into a torque value applied to the helical gear wheel.

10. A device as in claim 9, further comprising a control for converting the axial force to a torque value applied to the helical gear wheel, wherein the control is directly integrated into a subsequent control device of the transmission.

11. A device as in claim 1, wherein the axial force in the helical gear wheel is converted using the following function
Md=(F_ax/tan(beta))*r
into the torque applied to the helical gear wheel, whereby Md represents the torque, F_ax is the measured axial force, beta is the obliqueness of the angle of the gear wheel, and r is the effective radius of the meshing of the gear wheel.

12. A device as in claim 1, wherein a correction factor is applied during the conversion of the measured axial force of the helical gear wheel into the torque applied to the helical gear wheel.

13. A device as in claim 12, wherein the correction factor used during conversion of the axial force of the helical gear wheel into the torque applied to the helical gear wheel is given as a constant value.

14. A device as in claim 12, wherein the correction factor used during conversion of the axial force of the helical gear wheel into the torque applied to the helical gear wheel is given as a mathematical function of at least one variable.

15. A device as in claim 12, wherein the correction factor is determined empirically.

16. A device as in claim 12, wherein the correction factor is determined adaptively.

17. A device as in claim 12, wherein the axial force of the helical gear wheel is converted to the torque applied to the helical gear wheel using a function
Md=K*(F_ax/tan(beta))*r
whereby Md represents the torque, K is the correction factor, F_ax is the measured axial force, beta is the obliqueness of the angle of the gear wheel, and r is the effective radius of the meshing of the gear wheel.

18. A device as in claim 12, wherein the torque value determined from the actual axial force of the helical gear wheel is used for at least one of pressure control, regulation of shifting elements, and pressure control or regulation of an actuator to adjust a drive ratio of the transmission.

19. A device as in claim 12, wherein the correction factor used during conversion of the axial force of the helical gear wheel into the torque applied to the helical gear wheel is given as a mathematical function of an operating temperature of the transmission or on lubricant viscosity.

20. A method for determining torque in a transmission, whereby a torque actually applied, comprising determining an actual measured axial force on a bearing of a torque-transferring helical gear wheel of the transmission, and converting the axial force into an applied torque.
